(19) United States
(12) Patent Application Publication
(10) Pub. No.: US 2017/0152088 A1
(43) Pub. Date: Jun. 1, 2017

(54) Coextruded Film For Flexible Bags

(71) Applicant: Scholle IPN Corporation, Northlake, IL (US)

(72) Inventors: Joel Monroe, Chicago, IL (US); David Bellmore, DeWitt, MI (US)

(21) Appl. No.: 15/190,997

(22) Filed: Jun. 23, 2016

Related U.S. Application Data
(63) Continuation-in-part of application No. 14/954,888, filed on Nov. 30, 2015.

(51) Int. Cl. B65D 65/40; B65D 77/06; B32B 27/32; B32B 7/02; B32B 27/08

(52) U.S. Cl. CPC B65D 65/40; B32B 7/02; B32B 27/08; B32B 27/32; B65D 77/065; B32B 2307/72; B32B 2323/046; B32B 2439/46

(57) ABSTRACT

A film for a flexible bag comprising a plurality of coextruded layers. The layers include a core layer, a first skin layer and a second skin layer. The core layer is a polymer having a modulus equal to or less than 175 MPa. The core layer has a first side and a second side opposite the first side. The first skin layer is coextruded directly on the first side of the core layer. The first skin layer has a modulus greater than 175 MPa. The second skin layer is coextruded directly on the second side of the core layer. The second skin layer has a modulus greater than 175 MPa. A flexible bag is further disclosed.

### CROSS-REFERENCE TO RELATED APPLICATION

N/A

### BACKGROUND OF THE DISCLOSURE

1. Field of the Disclosure

The disclosure relates in general to flexible bag film construction, primarily for the storage, transport and/or dispensing of flowable material, such as liquids, purees, suspensions among others, and more particularly, to a coextruded film for flexible bags.

2. Background Art

The use of bag in box packaging is well known in the art. Generally, such packaging comprises a flexible bag made from a plurality of panels of a polymer film. The panels are coupled together through a plurality of seals to form a generally fluid tight cavity. A spout may be provided on one of the panels to provide ingress into the fluid tight cavity. The flexible bag may be placed within a rigid outer container or body for transport, storage and/or dispensing.

Such bags are generally filled with a flowable material and are generally shipped in, stored in and dispensed from a rigid outer container. Through storage, transport and use, the bags are subjected to various loads, some of which are repetitive loads. Such loads and movement of the flowable material within the flexible bag will degrade the bag and impart forces onto the flexible bag. Moreover, thermal reaction (such as from hot fill applications) further place stresses on the flexible bag and present a wide range of operational environments.

Thus, it is known that the bag must meet certain criteria relative to strength and operational performance. There is an ever present need to improve the film structures relative to performance, and cost. That is, there is a need to provide improved performance through films that are more easily and cost effectively produced. This is especially the case with the filling, transport and/or dispensing of hot fill products and the like.

### SUMMARY OF THE DISCLOSURE

The disclosure is directed to a film for a flexible bag comprising a plurality of coextruded layers. The layers comprise a core layer, a first skin layer and a second skin layer. The core layer comprises a polymer having a modulus equal to or less than 175 MPa. The core layer has a first side and a second side opposite the first side. The first skin layer is coextruded directly on the first side of the core layer. The first skin layer has a modulus greater than 175 MPa. The second skin layer is coextruded directly on the second side of the core layer. The second skin layer has a modulus greater than 175 MPa.

In some configurations, the core layer comprises a polyethylene material. In some configurations, the core layer comprises one of the group consisting of TPE, EMA, OBC, mPE, POP and POE. In some such configurations, the core layer has a density that is less than or equal to 0.916 g/cc.

In some configurations, the film has a thickness, with the core layer comprising 10% to 90% of the thickness of the film.

In some configurations, the first skin layer comprises a polyethylene material.

In some such configurations, the first skin layer comprises LLDPE. In some configurations, the film has a thickness, with the first skin layer comprising 5% to 45% of the thickness of the film.

In some configurations, the second skin layer comprises a polyethylene material. In some configurations, the second skin layer comprises LLDPE. In some such configurations, the film has a thickness, with the second skin layer comprising 5% to 45% of the thickness of the film.

In some configurations, the first skin layer and the second skin layer are substantially identical.

In some configurations, the core layer comprises 1.2 mil of 100% of one of mPE, POP and POE, the first skin layer comprises a 0.4 mil 100% LLDPE and the second skin layer comprises a 0.4 mil 100% LLDPE.

In another aspect of the disclosure, the disclosure is directed to a film for a flexible bag comprising a plurality of coextruded layers. The layers essentially consisting of a core layer, a first skin layer and a second skin layer. The core layer essentially consists of a polymer having a modulus equal to or less than 175 MPa. The core layer has a first side and a second side opposite the first side. The first skin layer is coextruded directly on the first side of the core layer. The first skin layer has a modulus greater than 175 MPa. The second skin layer is coextruded directly on the second side of the core layer. The second skin layer has a modulus greater than 175 MPa.

In some configurations, the film has a thickness, where the thickness of the core layer is between 10% and 90% of the thickness of the film, the first skin layer is between 5% and 45% of the thickness of the film and the second skin layer is between 5% and 45% of the thickness of the film.

In yet another aspect of the disclosure, the disclosure is directed to a flexible bag comprising a front panel, a back panel and a plurality of seals. The front panel has an outer surface and an inner surface opposite the outer surface. The back panel has an outer surface and an inner surface opposite the outer surface. The plurality of seals joins the front panel to the back panel with the inner surface of the front panel facing the inner surface of the back panel, to define a fluid cavity. Each of the front panel and the back panel comprising a film that is coextruded and includes a plurality of layers. The plurality of layers comprising a core layer, a first skin layer and a second skin layer. The core layer comprises a polymer having a modulus equal to or less than 175 MPa. The core layer has a first side and a second side opposite the first side. The first skin layer is coextruded directly on the first side of the core layer. The first skin layer has a modulus greater than 175 MPa. The second skin layer is coextruded directly on the second side of the core layer. The second skin layer has a modulus greater than 175 MPa. The first skin layer defines the outer surface of the bag, and the second skin layer defines the inner surface of the bag.

In some configurations, the core layer comprises one of the group consisting of TPE, EMA, OBC, mPE, POP and POE.

In some configurations, the core layer has a density that is less than or equal to 0.916 g/cc.

In some configurations, at least one of the first skin layer and the second skin layer comprises LLDPE.

In some configurations, the film has a thickness, with each of the first skin layer and the second skin layer comprising 5% to 45% of the thickness of the film.

### BRIEF DESCRIPTION OF THE DRAWINGS

The disclosure will now be described with reference to the drawings wherein:

FIG. 1 of the drawings is a perspective view of a flexible bag of the present disclosure;

FIG. 2 of the drawings is a perspective view of a rigid outer container into which the flexible bag of the present disclosure can be placed;

FIG. 3 of the drawings is a cross-sectional view of a flexible bag of the present disclosure, showing, in particular, the structure of the spout and the flexible bag, taken generally about lines 3-3 of FIG. 1;

FIG. 4 of the drawings is a cross-sectional view of the coextrusion structure of the film of the flexible bag;

FIG. 5 of the drawings is a graphic depiction of the test results of the six sample bags formed and explained after 6,000 cycles on a Gelbo Test; and

FIG. 6 of the drawings is a graphic depiction of the test results of the six sample bags formed and explained after 12,000 cycles in a Gelbo Test.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

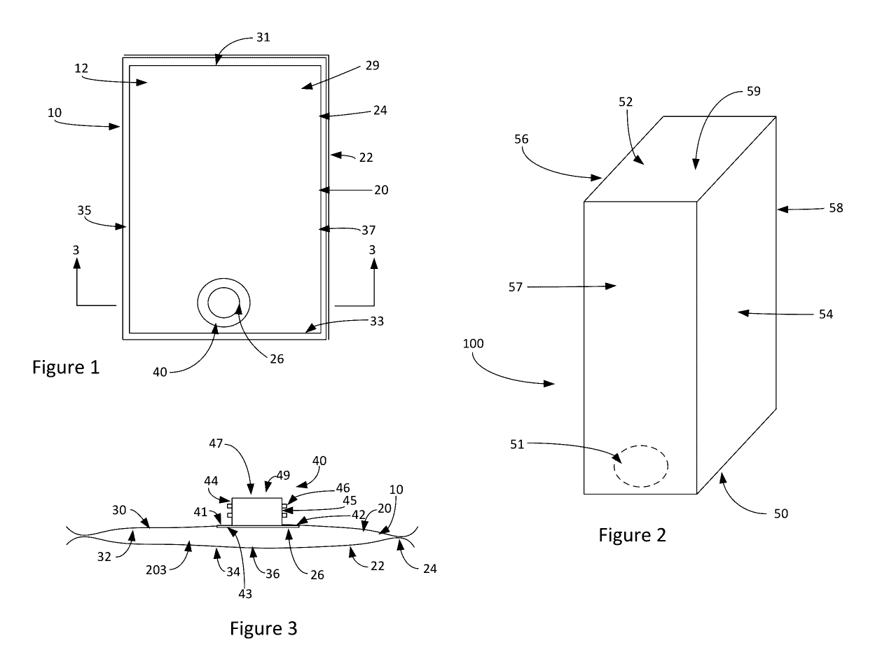

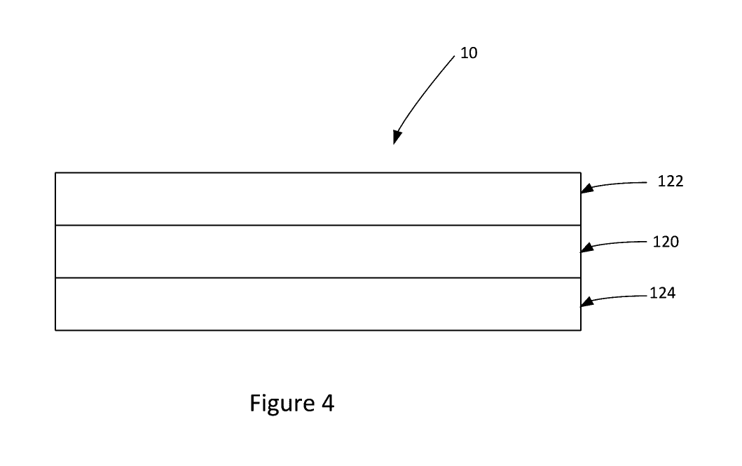

Referring now to the drawings and in particular to FIGS. 1, 2, 3 and 4, the film is shown generally at 10. The film comprises a three layer extrusion that can be formed into bags, such as bag 12. The bags can be used alone, or in combination with outer rigid containers, such as container 100. One such use is in association with bag-in-box packaging. In such applications, the bags may be used to store and dispense flowable material, including, but not limited to liquids, gels, syrups, such as soft drink syrup, beverages, such as wine, purees among other flowable material. It is contemplated that such a flowable material may comprise any number of different viscosities, and may include a solids content. The foregoing examples of flowable material are meant to be illustrative, and not deemed to be limiting. The present disclosed film is particularly useful for hot fill contents, as both the hot fill and flex crack characteristics are well suited for such an application.

One illustrative bag of the type contemplated for use that can be formed in part or in whole from the film of the present disclosure is shown in FIGS. 1 and 3 as comprising a commonly known pillow type bag. Such a bag includes front panel 20 and back panel 22. Front panel 20 includes outer surface 30 and inner surface 32. The back panel 22 includes outer surface 34 and inner surface 36. The front and back panel are positioned in an overlying orientation so that the inner surfaces face each other.

The panels are then coupled together by way of seals 24. In the case of a pillow type container, the seals 24 include a top seal 31, bottom seal 33, first side seal 35 and second side seal 37. The seals are generally perpendicular to adjacent seals and parallel to opposing seals to generally define a square or rectangular configuration, thereby defining a generally square or rectangular cavity 29. The seals may be formed through the application of heat, or through other procedures, including, but not limited to RF welding, ultrasonic welding, adhesive, among others. The disclosure is not limited to any particular manner of attachment of the panels.

For many pillow type containers, an opening 26 is provided through the front panel 20 proximate, but spaced apart from the bottom seal 33. A spout 40 can be coupled thereto in sealed engagement. In certain embodiments, multiple spouts may be provided, one, for example, for dispensing, and one for filling. In other embodiments, spouts may be positioned along the seals so as to extend between the panels. The film is configured for use in association with multiple configurations of spouts, as well as in embodiments that do not require spouts.

One type of spout is shown in FIG. 3 as comprising a base flange 42, and upstanding wall 44 extending from the base flange. The base flange includes top surface 41 and bottom surface 43 opposite top surface 41. Generally the base flange is substantially planar and generally perpendicular to the upstanding wall 44. Either one of the top and bottom surfaces may be sealed to the front panel about opening 26, through a heat seal. Of course, other sealing methods, such as those identified above may be utilized in place of heat sealing.

The upstanding wall includes an outer surface 45 which includes grasping flanges, such as grasping flange 46 extending about the outer surface. Generally, these grasping flanges are disposed in a spaced apart orientation along the outer surface, generally parallel to the base flange 42. Of course, other configurations are likewise contemplated. The upstanding wall defines a passageway, which is generally of a circular configuration, terminating at opening 49 spaced distally from the base flange 42. Of course, other cross-sectional configurations are contemplated, and the disclosure is not limited to any particular configuration of the spout.

It will be understood that such a bag may be positioned within an outer carton, such as an outer box 100 which is shown in FIG. 2. The outer box includes a bottom wall 50, top wall 52, first side wall 54, second side wall 56, front wall 57 and back wall 58. The outer box that is shown in the figures comprises a rectangular cubic configuration. Of course, such a configuration is merely exemplary, and not to be deemed limiting. It will be understood that other containers, such as those having fewer or greater number of sides (i.e., a hexagonal or octagonal box having a plurality of sides along with a bottom and top wall are contemplated as well). In some embodiments, one of the walls, and in the embodiment shown, the front wall 57, may include an opening 51 which provides access to the cavity 59, and the bag therein. In other embodiments, it may be necessary to remove one of the walls to gain access to cavity 59. It is contemplated that the outer carton comprises a paperboard material, such as a corrugated paperboard. Of course, other materials are likewise contemplated for use, including, but not limited to, other paperboard materials, polymer materials, including bio-polymers, and the like.

It will be understood that any number of different members may be coupled to the spout described above. For example, a cap or a dispensing fitment may be coupled to the above configuration. Such connectors may include those disclosed in U.S. Pat. No. 7,387,277 issued to Verespej et al, U.S. Pat. No. 7,469,522 issued to Verespej et al, U.S. Pat. No. 7,114,625 issued to Jones, et al, U.S. Pat. No. 8,448,799 issued to Thurman, as well as various Quick connect, disconnect fittings (QCD) that are utilized in association with soft drink syrups among others. It is also contemplated that dispensers such as those disclosed in U.S. Pat. Nos. 4,619,377 and 6,978,981 both of which are issued to Roos as well as U.S. Pat. Nos. 6,045,119; 6,296,157 and 6,360,925 issued to Erb, U.S. Pat. No. 8,336,743 issued to Bellmore, U.S. Pat. No. 7,240,811 issued to Roser. Additionally, it will be understood that the spout or the cavity may further include different structures to aid in the dispensing of flowable material. Among such structures, it is contemplated that the structures coupled to the spout, including but not limited to those shown in U.S. Pat. No. 5,749,493 issued to Boone et al, U.S. Pat. No. 5,941,421 issued to Overman et al and U.S. Pat. No. 6,102,252 issued to Overman et al, and U.S. Pat. No. 4,138,036 issued to Bond are contemplated for use. Each of the foregoing references are incorporated by reference in their entirety.

It will be understood that while a pillow type bag is shown, the film is not limited to use therewith. For example, the bay may comprise a gusseted bag wherein four panels are coupled together to form a generally rectangular shaped bag. One such configuration is shown in U.S. Pat. No. 5,788,121 issued to Sasaki et al. Another such configuration is shown in U.S. Pat. No. 6,783,277 issued to Edwards. The foregoing patents are incorporated by reference in their entirety.

The coextruded film 10 includes a core layer 120, first skin layer 122 and second skin layer 124. The second skin layer 124, in the configuration shown, comprises the product contact layer within the flexible bag and first skin layer 122 comprises the outer surface of the flexible bag made therefrom. It will be understood that the coextruded film comprises a three layer coextrusion. It will be understood that any one of the layers may be formed from multiple die openings that cooperatively form a structure that comprises a single layer. Most preferably, the coextrusion is formed from three distinct layers, each of which is formed from a single layer.

The core layer 120 comprises a polymer configuration that has a low modulus, that is, a modulus of less than or equal to 175 MPa. Additionally, the core layer 120 in some embodiments comprises a polyethylene having a low density, that is a density that is less than or equal to 0.916 g/cc. It will be understood that among other polyethylene compositions, it is contemplated that the core layer comprises a metallocene polyethylene (mPE), polyolefin plastomer (POP) or polyolefin elastomer (POE). The core layer may also comprise a thermoplastic elastomer (TPE) copolymer, Ethyl Methacrylate (EMA) or an Olefin Block Copolymer (OBC). In the composition of the overall coextruded film, the core layer 120 comprises between 10% and 90% of the thickness of the film. It is contemplated that the core layer includes a first side and a second side opposite the first side, with the two sides being substantially parallel to each other as the core layer is of substantially uniform thickness, preferably.

The first skin layer 122 comprises a polyethylene having good thermal resistance as a result of crystallinity, wherein the modulus is greater than 175 MPa. For example, the first skin layer 122 comprises a linear low density polyethylene (LLDPE) with such characteristics. The first skin layer 122 comprises between 5% and 45% of the overall thickness of the film.

The second skin layer 124 comprises a polyethylene having a good thermal resistance as a result of crystallinity, wherein the modulus is greater than 175 MPa. For example, the second skin layer 124 comprises a linear low density polyethylene (LLDPE) with such characteristics. The second skin layer 124 comprises between 5% and 45% of the overall thickness of the film. It is contemplated that the first skin layer and the second skin layer may comprise the same material composition, or they may be varied. In addition, the two layers may have the same thickness or the thicknesses may vary.

It is contemplated that the first and second skin layers are substantially uniform layers having substantially uniform thickness (although they may be of different thickness relative to each other), such that the cross-sectional configuration of the film is substantially uniform along the length and width thereof.

As will be understood, the core layer is formed with the first skin layer 122 being directly coextruded on a first side of the core layer, so that the two layers are directly on one another. The second skin layer 124 is coextruded directly onto the second side of the core layer so as to be on the opposite side thereof relative to the first skin layer. As such, it is contemplated that in the configuration shown, the first skin layer is directly on the core layer and the second skin layer is directly on the core layer on the opposite side of the first skin layer.

For example, a sample film 10 may be formed from a coextrusion wherein the core layer 20 comprises a 1.2 mil 100% mPE, POP or POE. In such a configuration, the first skin layer 22 may be formed from 0.4 mil 100% LLDPE with additives such as anti-block, slip, anti-oxidant and polymer processing aid. The second skin layer 24 may be formed from 0.4 mil 100% LLDPE with additives such as anti-block, slip, anti-oxidant and polymer processing aid. As such, the entire film is 2.0 mil with the core layer comprising 60% of the overall thickness.

Another example, a sample film 10 may be formed from a coextrusion wherein the core layer 20 comprises a 1.6 mil 100% mPE, POP or POE. In such a configuration, the first skin layer 22 may be formed from 0.2 mil 100% LLDPE with additives such as anti-block, slip, anti-oxidant and polymer processing aid. The second skin layer 24 may be formed from 0.2 mil 100% LLDPE with additives such as anti-block, slip, anti-oxidant and polymer processing aid. As such, the entire film is 2.0 mil with the core layer comprising 80% of the overall thickness.

Another example, a sample film 10 may be formed from a coextrusion wherein the core layer 20 comprises a 1.2 mil 100% thermoplastic elastomer (TPE). In such a configuration, the first skin layer 22 may be formed from 0.4 mil 100% LLDPE with additives such as anti-block, slip, anti-oxidant and polymer processing aid. The second skin layer 24 may be formed from 0.4 mil 100% LLDPE with additives such as anti-block, slip, anti-oxidant and polymer processing aid. As such, the entire film is 2.0 mil with the core layer comprising 60% of the overall thickness.

A number of sample bags have been prepared to test the performance of the bags. In one contemplated embodiment, a three ply bag was formed. The inner ply comprised a film made in accordance with the present disclosure. Specifically, such a film included having the following structure:
Layer 1: 0.4-mil 100% LLDPE with additives
Layer 2: 1.2-mil 100% mPE
Layer 3: 0.4-mil 100% LLDPE with additives
   The performance of the film was then tested under a number of different parameters. The testing was also compared with a competitive sample. These tests included physical properties testing and bag transport simulation testing. The competitive structure was the same thickness as the disclosure (2.0-mil).

The physical properties testing tested puncture strength (grams) and Gelbo Flex testing (number of holes per 6,000 cycles and 12,000 cycles). The bag produced with the film in accordance with the present disclosure exhibited a puncture strength which was greater than the competitive films, and a fewest number of holes in the Gelbo Flex testing. The chart below details the results of the physical testing.

| | Disclosure | Competitive |
|---|---|---|
| Puncture Strength | 3,600 | 700 |
| (grams) | | |
| Gelbo Flex Test | 8 | 23 |
| (# holes per 6,000 cycles) | | |
| Gelbo Flex Test | 15 | 31 |
| (# holes per 12,000 cycles) | | |

With respect to the bag transport simulations, testing was undertaken relative to bags formed from the disclosure and competitive films. The test was conducted with filled 55 gallon bags on a two-axis vibration table, at 185 revolutions per hour for 60 minutes. The bag formed from film of the present disclosure outperformed the competitive film. Details are below.

| | Disclosure | Competitive |
|---|---|---|
| Number of Leaks after 60 minutes | 1.7 | 12.5 |

Thus in all three of the tests, the bag made in accordance with the present disclosure exhibited significantly improved performance over the prior art competitive film.

Further testing was undertaken through the creation of several different structures of film which were then formed into pillow type bags.

The first bag had a film structure that was formed from a 238 MPa LLDPE as a monolithic structure. The thickness of the film structure of the first bag was 2.0-mil.

The second bag had a film structure that was formed from a core layer and two outer layers, one on either side of the core layer. The core layer comprised a 1.2-mil thick structure of 228 MPa PE Copolymer. Each of the outer layers comprised a 0.4-mil thick 238 MPa LLDPE (same material from which the first bag was formed). The total thickness of the film structure of the second bag was 2.0-mil, the same as the film of the first bag.

The third bag had a film structure that was formed from a core layer and two outer layers, one on either side of the core layer. The core layer comprised a 1.2-mil thick structure of 130 MPa mPE. Each of the outer layers comprised a 0.4-mil thick 238 MPa LLDPE (same material from which the outer layers of the second bag were formed). The total thickness of the film structure of the third bag was 2.0-mil, the same as the film of the first bag.

The fourth bag had a film structure that was formed from a core layer and two outer layers, one on either side of the core layer. The core layer comprised a 1.2-mil thick structure of 97 MPa mPE. Each of the outer layers comprised a 0.4-mil thick 238 MPa LLDPE (same material from which the outer layers of the second bag were formed). The total thickness of the film structure of the fourth bag was 2.0-mil, the same as the film of the first bag.

The fifth bag had a film structure that was formed from a core layer and two outer layers, one on either side of the core layer. The core layer comprised a 1.2-mil thick structure of 2 MPa Olefin Block Copolymer (OBC). Each of the outer layers comprised a 0.4-mil thick 238 MPa LLDPE (same material from which the outer layers of the second bag were formed). The total thickness of the film structure of the fifth bag was 2.0-mil, the same as the film of the first bag.

The sixth bag had a film structure that was formed from a core layer and two outer layers, one on either side of the core layer. The core layer comprised a 1.2-mil thick structure of a 39 MPa EMA. Each of the outer layers comprised a 0.4-mil thick 238 MPa LLDPE (same material from which the outer layers of the second bag were formed). The total thickness of the film structure of the sixth bag was 2.0-mil, the same as the first bag.

The seventh bag had a film structure that was formed from a core layer and two outer layers, one on either side of the core layer. The core layer comprised a 0.72-mil thick 2 MPa Thermoplastic Elastomer (TPE) copolymer. Each of the outer layers comprised a 0.62-mil thick 238 MPa LLDPE (same material from which the outer layers of the second bag were formed). The total thickness of the film structure of the sixth bag was 2.0-mil, the same as the first bag.

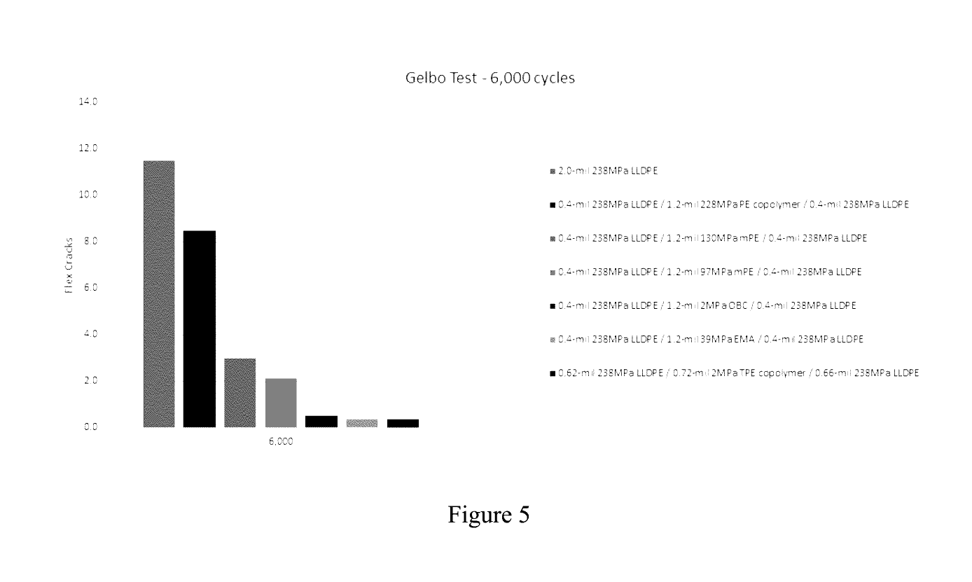

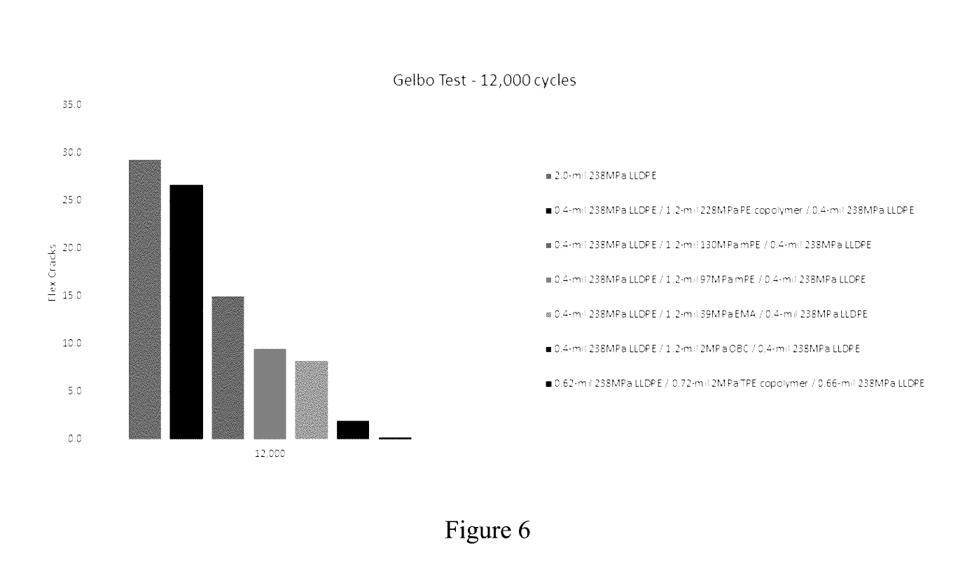

The results, shown in FIGS. 5 and 6 demonstrate that the bags formed from films of the present disclosure (namely, bags three through seven) exhibited greatly reduced flex cracking as compared to conventionally formed bags (namely, bags one and two). For example, over 6,000 cycles, as is shown in FIG. 5, the bags of the films of the present disclosure had less than half the flex cracks of the second bag and almost a fourth of the flex cracks of the first bag. Over 12,000 cycles, as is shown in FIG. 6, the differences can be seen between the bags of the present disclosure and conventionally formed bags. The conventionally formed bags had over 25 flex cracks, whereas the bags formed from films of the present disclosure had 15 or fewer flex cracks with four of the five bags having fewer than 10 flex cracks (two of which bags had less than 3 flex cracks). Thus, the bags formed from the films of the present disclosure performed substantially better than those formed from conventional material constructions.

The foregoing description merely explains and illustrates the invention and the invention is not limited thereto except insofar as the appended claims are so limited, as those skilled in the art who have the disclosure before them will be able to make modifications without departing from the scope of the invention.

1. A film for a flexible bag comprising a plurality of coextruded layers, the layers comprising:
a core layer comprising a polymer having a modulus equal to or less than 175 MPa, the core layer having a first side and a second side opposite the first side;
a first skin layer coextruded directly on the first side of the core layer, the first skin layer having a modulus greater than 175 MPa; and
a second skin layer coextruded directly on the second side of the core layer, the second skin layer having a modulus greater than 175 MPa.

2. The film for a flexible bag of claim 1 wherein the core layer comprises a polyethylene material.

3. The film for a flexible bag of claim 1 wherein the core layer comprises one of the group consisting of TPE, EMA, OBC, mPE, POP and POE.

4. The film for a flexible bag of claim 1 wherein the core layer has a density that is less than or equal to 0.916 g/cc.

5. The film for a flexible bag of claim 1 wherein the film has a thickness, with the core layer comprising 10% to 90% of the thickness of the film.

6. The film for a flexible bag of claim 1 wherein the first skin layer comprises a polyethylene material.

7. The film for a flexible bag of claim 6 wherein the first skin layer comprises LLDPE.

8. The film for a flexible bag of claim 7 wherein the film has a thickness, with the first skin layer comprising 5% to 45% of the thickness of the film.

9. The film for a flexible bag of claim 1 wherein the second skin layer comprises a polyethylene material.

10. The film for a flexible bag of claim 9 wherein the second skin layer comprises LLDPE.

11. The film for a flexible bag of claim 10 wherein the film has a thickness, with the second skin layer comprising 5% to 45% of the thickness of the film.

12. The film for a flexible bag of claim 1 wherein the first skin layer and the second skin layer are substantially identical.

13. The film for a flexible bag of claim 1 wherein the core layer comprises 1.2 mil of 100% of one of mPE, POP and POE, the first skin layer comprises a 0.4 mil 100% LLDPE and the second skin layer comprises a 0.4 mil 100% LLDPE.

14. A film for a flexible bag comprising a plurality of coextruded layers, the layers essentially consisting of:
a core layer essentially consisting of a polymer having a modulus equal to or less than 175 MPa, the core layer having a first side and a second side opposite the first side;
a first skin layer coextruded directly on the first side of the core layer, the first skin layer having a modulus greater than 175 MPa; and
a second skin layer coextruded directly on the second side of the core layer, the second skin layer having a modulus greater than 175 MPa.

15. The film for a flexible bag of claim 14 wherein the film has a thickness, with the thickness of the core layer being between 10% and 90% of the thickness of the film, the first skin layer being between 5% and 45% of the thickness of the film and the second skin layer being between 5% and 45% of the thickness of the film.

16. A flexible bag comprising:
a front panel having an outer surface and an inner surface opposite the outer surface;
a back panel having an outer surface and an inner surface opposite the outer surface; and
a plurality of seals joining the front panel to the back panel with the inner surface of the front panel facing the inner surface of the back panel, to define a fluid cavity;
each of the front panel and the back panel comprising a film that is coextruded and includes a plurality of layers, the plurality of layers comprising:
a core layer comprising a polymer having a modulus equal to or less than 175 MPa, the core layer having a first side and a second side opposite the first side;
a first skin layer coextruded directly on the first side of the core layer, the first skin layer having a modulus greater than 175 MPa; and
a second skin layer coextruded directly on the second side of the core layer, the second skin layer having a modulus greater than 175 MPa,
wherein the first skin layer defines the outer surface of the bag, and the second skin layer defines the inner surface of the bag.

17. The flexible bag of claim 16 wherein the core layer comprises one of the group consisting of TPE, EMA, OBC, mPE, POP and POE.

18. The flexible bag of claim 17 wherein the core layer has a density that is less than or equal to 0.916 g/cc.

19. The flexible bag of claim 16 wherein at least one of the first skin layer and the second skin layer comprises LLDPE.

20. The flexible bag of claim 16 wherein the film has a thickness, with each of the first skin layer and the second skin layer comprising 5% to 45% of the thickness of the film.
